(19) United States
(12) Patent Application Publication
(10) Pub. No.: US 2006/0053906 A1
(43) Pub. Date: Mar. 16, 2006

(54) Method and apparatus for grain sample storage

(76) Inventor: Brian Krywko, Morinville (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/223,301

(22) Filed: Sep. 9, 2005

(30) Foreign Application Priority Data
Sep. 10, 2004 (CA) 2,480,498

(51) Int. Cl. G01N 1/00

(52) U.S. Cl. 73/864.31

(57) ABSTRACT

A method and apparatus for grain sample storage. A first step involves securing to an outside wall of a grain bin, a dedicated weather resistant and vermin resistant storage container capable of holding numerous small grain samples. A second step involves storing the numerous small grain samples required in order to provide a representative grain sample of the contents of the grain bin in the storage container. By following the teachings of this method the representative grain sample is safely and conveniently stored in the storage container positioned on the grain bin with which the representative grain sample is associated.

### FIELD OF THE INVENTION

The present invention relates to a method and an apparatus for grain sample storage.

### BACKGROUND OF THE INVENTION

Farmers are paid for grain based upon the grade of grain that they deliver. The grade is determined by such factors as: colour, quality and green count. Samples used to be taken from a grain bin by opening the door of the grain bin, and collecting a sample of grain just inside the door. It was determined that this form of sampling did not provide a representative sample. Grain probes were then used, which could be extended through the open grain bin door and eight to ten feet into the grain bin. This was a better sampling technique, but still did not provide a representative sample. The best method currently available for grain sampling is to provide a five gallon pail for each grain bin. As grain is delivered to the grain bin, a small sample is placed in the five gallon pail. The accumulation of these numerous small samples, results in the contents of the five gallon pail being representative of the contents of the grain bin. If the contents of the five gallon pail are mixed, and a sample taken, such a sample is representative of the contents of the grain bin.

Problems are currently being experienced with the five gallon pail sampling method. Grain farmers frequently have between thirty and eighty grain bins. In order to follow this sampling method, they must use between thirty and eighty five gallon pails. They must, therefore, find someplace to store the five gallon pails, where the sample is protected from the elements. They must develop a system of identifying the five gallon pails, so they will know to which grain bin the contents of each five gallon pail has come. Unfortunately, identification systems are frequently inadequate and the farmers are becoming confused as to the origin of the grain in the five gallon pails. The five gallon pails are an ideal breeding ground for mice and other vermin. The samples are, therefore, becoming contaminated and rendered useless by such contamination.

### SUMMARY OF THE INVENTION

What is required is a method and an apparatus for grain sample storage, which will overcome these problems.

According to one aspect of the present invention there is provided a method for grain sample storage. A first step involves securing to an outside wall of a grain bin, a dedicated weather resistant and vermin resistant storage container capable of holding numerous small grain samples. A second step involves storing the numerous small grain samples required in order to provide a representative grain sample of the contents of the grain bin in the storage container. By following the teachings of this method the representative grain sample is safely and conveniently stored in the storage container positioned on the grain bin with which the representative grain sample is associated.

According to another aspect of the present invention there is provided an apparatus for grain sample storage, which includes a grain bin having an outside wall. A dedicated weather resistant and vermin resistant storage container capable of holding numerous small grain samples is mounted to the outside wall. The numerous small grain samples required in order to provide a representative sample of the contents of the grain bin are safely and conveniently stored in the storage container.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

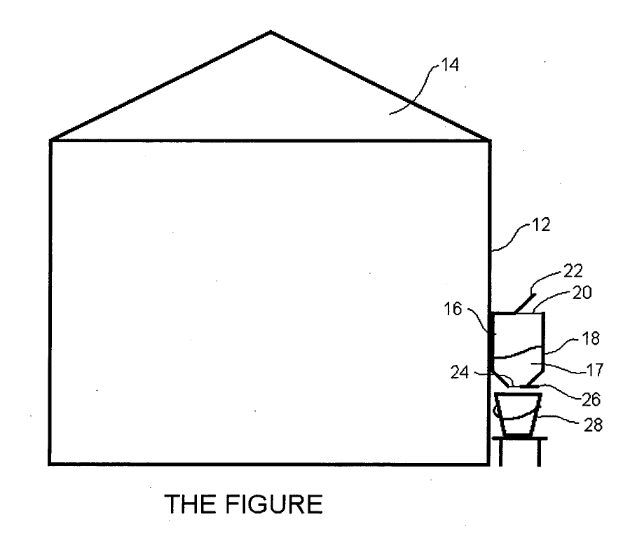

THE FIG. 1 is a side view of the grain bin and storage container used in the method according to the teachings of the present invention.

### DETAILED DESCRIPTION OF THE PREFERRED EMBODIMENT

The preferred method for grain sample storage, will now be described with reference to THE FIGURE.

With reference to THE FIGURE, the method consists of the steps of securing to an outside wall 12 of a grain bin 14, a dedicated weather resistant and vermin resistant storage container 16 capable of holding numerous small grain samples. It will be understood that while a cylindrical grain bin has been depicted, storage container 16 may be used in conjunction with other types of storage containers for grain which are known, such as a grain bin with a hopper on the bottom. The numerous small grain samples are required in order to provide a representative grain sample 17 of the contents of grain bin 14 in storage container 16 are stored such that representative grain sample 17 is safely and conveniently stored in storage container 16 positioned on grain bin 14 with which representative grain sample 17 is associated.

Structure and Relationship of Parts:

Storage container 16 is in the form of a hopper 18 having an upper inlet 20 with an associated upper closure 22 and a lower outlet 24 with an associated lower closure 26.

Operation:

As grain bin 14 is loaded, small samples are taken periodically and placed in hopper 18 through upper inlet by opening upper closure. Representative grain sample 17 may then stay in hopper 18, which is weather resistant and vermin resistant, until sample 17 is needed. At that time, sample 17 passes through lower outlet 24 by opening lower closure 26 and into bucket 28. While the position of hopper 18 on wall 12 of grain bin 14 is not of great importance, it is preferable to have hopper 18 at a height where convenient access to the top is provided, and such that bucket 28 may be easily placed beneath.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

1. A method for grain sample storage, comprising the steps of:
securing to an outside wall of a grain bin, a dedicated weather resistant and vermin resistant storage container capable of holding numerous small grain samples;
storing the numerous small grain samples required in order to provide a representative grain sample of the contents of the grain bin in the storage container, such that the representative grain sample is safely and conveniently stored in the storage container positioned on the grain bin with which the representative grain sample is associated.

2. The method for grain sample storage as defined in claim 1, the storage container being in the form of a hopper having an upper inlet with an associated upper closure and a lower outlet with an associated lower closure.

3. An apparatus for grain sample storage, comprising in combination:
a grain bin having an outside wall;
a dedicated weather resistant and vermin resistant storage container capable of holding numerous small grain samples, such that the numerous small grain samples required in order to provide a representative sample of the contents of the grain bin are safely and conveniently stored in the storage container.

4. The apparatus for grain sample storage as defined in claim 3, wherein the storage container is in the form of a hopper having an upper inlet with an associated upper closure and a lower outlet with an associated lower closure.
